(19) United States
(12) Patent Application Publication
(10) Pub. No.: US 2008/0314873 A1
(43) Pub. Date: Dec. 25, 2008

(54) SWITCHING CHAMBER FOR A HIGH-VOLTAGE SWITCH HAVING A HEATING VOLUME FOR HOLDING QUENCHING GAS PRODUCED BY SWITCHING ARCS

(75) Inventors: Andreas DAHLQUIST, Malmo (SE); Christian Franck, Zurich (CH); Martin Seeger, Zurich (CH)

Correspondence Address: BUCHANAN, INGERSOLL & ROONEY PC, POST OFFICE BOX 1404, ALEXANDRIA, VA, 22313-1404, US

(73) Assignee: ABB Research Ltd, Zurich (CH)

(21) Appl. No.: 12/200,379

(22) Filed: Aug. 28, 2008

Related U.S. Application Data
(63) Continuation of application No. PCT/CH2007/000056, filed on Feb. 6, 2007.

(30) Foreign Application Priority Data
Feb. 28, 2006 (EP) 06405084.2

(51) Int. Cl. H01H 33/00

(52) U.S. Cl. 218/53

(57) ABSTRACT

A switching chamber is intended for a gas-insulated high-voltage switch and contains a contact arrangement with two arcing contacts, which move relative to one another along an axis, with an insulating nozzle, an insulating auxiliary nozzle, a heating volume and a heating channel. The heating channel is routed partially axially between the insulating nozzle and the insulating auxiliary nozzle and connects an arcing zone to the heating volume. A section of the heating channel which opens into the heating volume is inclined inward with respect to the axis. Hot gas which is formed when a short-circuit current is disconnected in the arcing zone therefore flows with a velocity component directed inward into the heating volume, and can penetrate deeply into the heating volume in areas close to the axis. The quality of a quenching gas which is formed in the heating volume from the hot gas and cold gas which is already present, with this quenching gas being used to blow a switching arc which has been struck in the arcing zone during disconnection, can thus be improved.

### RELATED APPLICATIONS

This application claims priority under 35 U.S.C. §119 to EP Application 06405084.2 filed in Europe on Feb. 28, 2006, and as a continuation application under 35 U.S.C. §120 to PCT/CH2007/000056 filed as an International Application on Feb. 6, 2007 designating the U.S., the entire contents of which are hereby incorporated by reference in their entireties.

### TECHNICAL FIELD

The present disclosure relates to a switching chamber for a high-voltage switch having a heating volume. The disclosure also relates to a switch having a switching chamber such as this.

### BACKGROUND INFORMATION

The switching chamber of the type mentioned initially allows short-circuit currents in the region of 50 or more kiloamperes to be disconnected in the voltage range up to several hundred kilovolts. It contains an axially symmetrical contact arrangement with two arcing contacts which move relative to one another along an axis, an insulating nozzle, an insulating auxiliary nozzle, a heating volume and a heating channel which is routed partially axially between the insulating nozzle and the insulating auxiliary nozzle and connects an arcing zone to the heating volume. The arcing zone, which holds a high-power switching arc when a short-circuit current is being disconnected, is bounded, when disconnecting a short-circuit current in the axial direction by the two arcing contents, and in the radial direction by the insulating nozzle and the insulating auxiliary nozzle. Hot gas formed by the switching arc is passed from the arcing zone via a heating channel into a heating volume which coaxially surrounds the switching pieces. The hot gas which has been fed into the heating volume is mixed with cold gas that is already present and, when the current to be disconnected approaches a zero crossing, is fed into the arcing zone as a quenching gas, in order to blow the switching arc.

The disconnection rating, which is governed by the dielectric strength of the switching chamber, of a high-voltage switch equipped with this switching chamber depends on the density of the quenching gas, that is to say on the pressure and the temperature of the quenching gas. If hot and cold gas are mixed with one another only incompletely, then hot-gas bubbles may still be present in the heating volume after the zero crossing of the short-circuit current and these bubbles return with the quenching gas into the arcing zone and may possibly lead to undesirable restriking.

Embodiments of a switching chamber of the type mentioned initially are described in DE 39 15 700 A1 and DE 199 36 987 C1. In an embodiment of this switching chamber which is illustrated in FIG. 3 in DE 39 15 700 A1, an axially symmetrical heating channel in the form of a hollow body and with an outer surface that is inclined inward with respect to the axis of symmetry opens into a heating volume. In an embodiment of the switching chamber illustrated in FIG. 1 in DE 199 36 987 C1, the heating channel has a section, which is inclined inward with respect to an axis of symmetry of the switching chamber and tapers in the form of a hollow truncated cone, which opens into the heating volume.

U.S. Pat. No. 4,716,266 A and U.S. Pat. No. 4,774,388 A describes switching chambers in which the heating channel in each case has a section which opens into the heating volume and contains a plurality of channel elements arranged offset with respect to one another in the circumferential direction of the mouth section. In an embodiment of these switching chambers which is illustrated in FIG. 8 of U.S. Pat. No. 4,474,388 A, the channel elements have a cross-sectional profile in the form of a banana.

A further switching chamber is described in DE 199 10 166 A1. In this switching chamber, an arcing zone which is formed during disconnection and is axially bounded by two arcing contacts communicates via an axially symmetrical heating channel with a heating volume in the form of a torus. The heating channel has a section which is inclined outward with respect to the axis of symmetry and opens into the heating volume. Hot gas formed by a switching arc in the arcing zone therefore enters the heating volume with a velocity component outward away from the axis.

The report by D. Yoshida, H. Ito, H. Kohyama, T. Sawada, K. Kamei and M. Hidaka entitled “Evaluation of Current Interrupting Capability of SF₆ Gas Blast Circuit Breakers”, Proceedings of the XIV International Conference on Gas Discharge and their Applications (Liverpool, Sep. 2-6, 2002), discloses that it is advantageous for good thorough mixing of a toroidal heating volume, into which hot gas flows axially and which contains cold gas, of a switching chamber for the ratio of the length L of this volume in the axial direction to the square root of the cross section A at right angles to the axis to be about 0.5. Furthermore, Georges Gaudart, Pierre Chevrier, Vicenzo Girlando and Antonio Lubello describe, in the report “New Circuit Breaker 245 kV 50 kA 50 Hz and 60 HZ with a very low operating energy”, 2nd European Conference on HV & MV Substation Equipment (Lyons, France, Nov. 20-21, 2003), a switching chamber for a high-voltage circuit breaker, in which a toroidal heating volume is provided for drive assistance, into which the heating channel opens axially. In order to improve the thorough mixing of hot gas flowing in and cold gas that is already present, guide elements, which are in the form of a tube and are routed axially into the heating volume, for the hot gas are arranged adjacent to the mouth of the heating volume.

### SUMMARY

Exemplary embodiments disclosed herein are directed to a switching chamber of the type mentioned initially in which cold gas and hot gas produced during disconnection are effectively thoroughly mixed in order to form a high-quality quenching gas, using simple means, thus ensuring that the switching chamber and a switch equipped with this switching chamber have a good disconnection rating.

A switching chamber for a gas-insulated high-voltage switch is disclosed having a contact arrangement, containing two arcing contacts which move relative to one another along an axis, an insulating nozzle, an insulating auxiliary nozzle, a heating volume and a heating channel which is routed partially axially between the insulating nozzle and the insulating auxiliary nozzle and connects an arcing zone to the heating volume, which heating channel has a section which is inclined inward with respect to the axis and opens into the heating volume, wherein the heating channel has a largely constant cross section over its entire length.

In another aspect, a switching chamber arrangement for a gas-insulated high-voltage switch is disclosed. Such an arrangement comprises a contact arrangement based on two arcing contacts which move relative to one another along an axis; an insulating nozzle; an insulating auxiliary nozzle; a heating volume; and a heating channel formed partially axial between the insulating nozzle and the insulating auxiliary nozzle. The heating channel connects an arcing zone to the heating volume, which heating channel becomes inclined inward with respect to the axis and opens into the heating volume. The heating channel has a defined cross section of a given length.

### BRIEF DESCRIPTION OF THE DRAWINGS

Exemplary embodiments of the disclosure will be explained in more detail in the following text with reference to the drawings, in which:

FIG. 1 shows an elevation of an axial section of a part, located above an axis, of a first exemplary embodiment of a switching chamber according to the disclosure,

FIG. 2 shows an elevation of a section along the line II-II through the switching chamber as shown in FIG. 1,

FIG. 3 shows an elevation of a section positioned in a corresponding manner to that in FIG. 2 through a second exemplary embodiment of the switching chamber according to the disclosure,

FIG. 4 shows an elevation of a section positioned in a corresponding manner to that in FIG. 2 through a third exemplary embodiment of the switching chamber according to the disclosure, and

FIG. 5 shows an elevation of an axial section through a part, located above an axis, of a fourth exemplary embodiment of a switching chamber according to the disclosure.

### DETAILED DESCRIPTION

In the switching chamber and the switch according to the disclosure, the heating channel has a section which is inclined inward with respect to an axis and opens into the heating volume, and the heating channel has a largely constant cross section over its entire length.

This measure results in the flow rate of the hot gas being kept constant while maintaining a velocity component that is directed inward throughout the entire mouth section. The probability of undesirable premature vortex formation in the heating channel resulting from flow inhomogeneities is thus reduced.

Furthermore, hot gas flowing into the heating volume has a velocity component which is directed inward and is guided along an axially aligned inner wall of the heating volume to a rear wall which axially bounds the heating volume in the flow direction. The velocity component directed inward prevents the hot-gas flow from separating from the inner wall, and therefore allows the hot gas to penetrate deeply into the heating volume in areas close to the axis. At the same time, cool quenching gas which is present in the heating volume then results in only a relatively low level of flow resistance to the hot gas flowing in, so that the velocity of the hot gas flowing in is not significantly reduced. A vortex formation process which promotes the mixing of the hot gas with cool quenching gas therefore takes place only at a relatively long distance from the mouth of the heating channel into the heating volume. The vortex that is formed remains largely stable, because of the low viscosity of the hot gas, over a comparatively long time period of several milliseconds, so that cool gas remains at the mouth of the heating channel into the heating volume over this time period. When the current which is to be disconnected approaches a zero crossing and quenching gas starts to flow from the heating volume into the arcing zone, then cool quenching gas for blowing the switching arc is available even at the start of an arc quenching process. This and quenching gas that flows out subsequently and has good quenching characteristics, and which is formed by intensive mixing as a result of the long-lasting vortex in a part of the heating volume facing away from the mouth, ensure that short-circuit currents of different magnitude and duration can be successfully interrupted.

Furthermore, on the other hand, the mouth section profile that is inclined inward makes it possible to reduce the dimensions of the heating volume in the radial direction. An insulating auxiliary nozzle which bounds the heating channel on its inside can be inclined at the point where the heating channel opens into the heating volume such that the inner wall of the heating volume is then formed by a contact mount, with a small diameter, of an arcing contact of the switching chamber. The external diameter of the heating volume can thus be reduced, therefore decreasing the manufacturing costs of the switching chamber.

Large inclination angles admittedly allow financially advantageous reduction in the external diameter of the heating volume, but, as the inclination angles increase in size, the heating gas flow has an increasing tendency to separate prematurely from the inner wall. Above an inclination angle of 45° this separation tendency is already relatively strongly pronounced at specific flow rates. Particularly good axially oriented guidance of the hot gas into the interior of the heating volume, with the heating volume external diameter being kept small at the same time, has been achieved with an inclination angle of between 100 and 30°

The mouth section is advantageously configured in the form of a hollow truncated cone which tapers in the inclination direction. A mouth section such as this can be achieved by implementation of the following measures:

Inclination of an insulating auxiliary nozzle, fixing of the insulating auxiliary nozzle to the contact mount of the abovementioned arcing contact, formation of a conical surface, which bounds the mouth section on the outside and forms a casing surface of the hollow truncated cone, in the insulating nozzle, and fixing of the insulating nozzle.

If this casing surface is bounded by a sharp edge in the form of a ring at the junction from the mouth section to the heating volume, then this edge makes it easier for the hot-gas flow to separate from the casing surface while at the same time additionally assisting the formation of the vortex on the rear wall of the heating volume. In the case of a weak hot-gas flow produced by a low-power switching arc, a vortex which promotes the mixing of the hot gas and cold gas is therefore reliably formed downstream from the edge, and leads to a good-quality quenching gas even for low-power switching arcs. A further improvement in the routing of the hot-gas flow and therefore also in the dielectric characteristics of the quenching gas is achieved by arranging the sharp edge on a ring which projects into the heating volume in the form of a tab.

The advantageous effects of the inclined heating channel are largely retained if the mouth section has at least two channel elements which extend in the inclination direction and are arranged offset with respect to one another in the circumferential direction. This is particularly true when the channel elements each have a cross-sectional profile in the form of a banana.

If the heating channel has a largely constant cross section over its entire length, then the flow rate of the hot gas can also be kept constant while maintaining a velocity component directed inward throughout the entire mouth section. The probability of undesirable premature vortex formation in the heating channel resulting from flow inhomogeneities is thus reduced.

If the mouth section is in the form of a hollow truncated cone which tapers in the inclination direction, then the constant cross section in the mouth section is achieved by the inner surface of the hollow truncated cone being more sharply inclined than its casing surface. Such an exemplary heating volume promotes the formation and stabilization of the vortex in a part of the heating volume downstream from the mouth.

If the heating volume is in the form of a torus and has a predominantly rectangular cross section in the circumferential direction, then it is advantageous for the formation and stabilization of the hot-gas vortex, and therefore also for the quality of the quenching gas achieved by mixing hot gas and cold gas, for the ratio of the length of the torus in the axial direction to the height of the torus in the radial direction to be between 1 and 3.

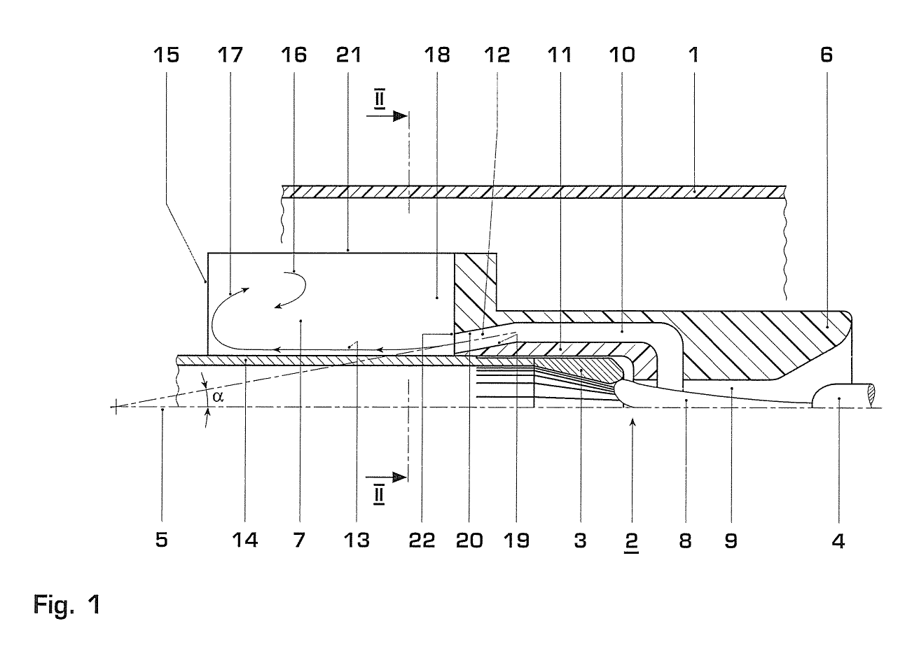

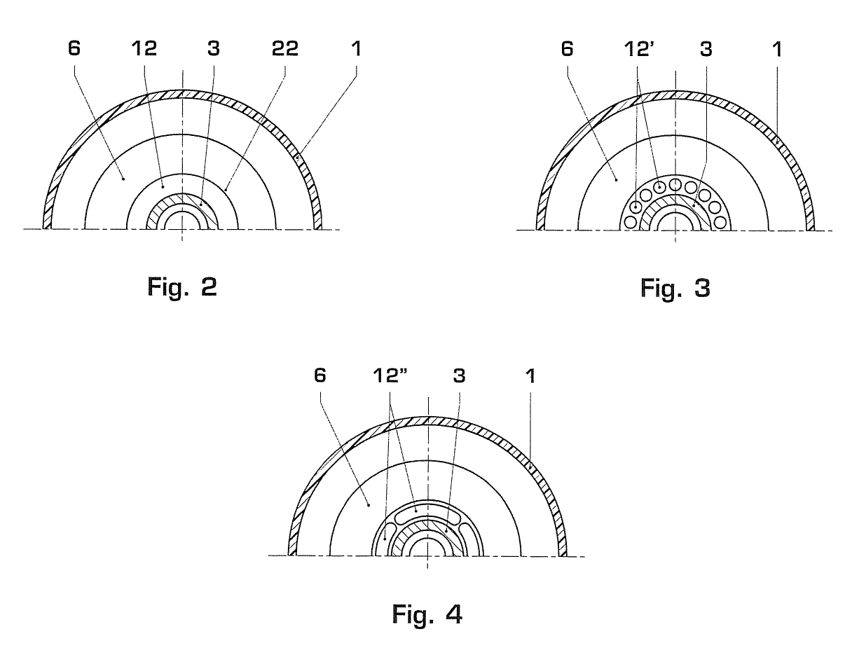

The same reference symbols relate to parts having the same effect in all the figures. The switching chamber, as illustrated in FIGS. 1 and 2, of a high-voltage circuit breaker contains a housing 1, which is largely axially symmetrical and is filled with a compressed insulating gas, for example based on sulfur hexafluoride, nitrogen, oxygen or carbon dioxide or mixtures of these gases with one another, for example air, and a contact arrangement 2 which is held by the switching chamber housing 1 and is likewise largely axially symmetrical. Two arcing contacts 3, 4 of the contact arrangement 2, which is illustrated during a disconnection process, are illustrated, of which the arcing contact 3 is arranged such that it can move along an axis 5, and the arcing contact 4 is held fixed in the housing 1. The arcing contact 4 need not necessarily be fixed, and it may also be moveable. The two arcing contacts 3, 4 are coaxially surrounded by an insulating nozzle 6 and a heating volume 7 in order to store quenching gas. The heating volume 7 is in the form of a torus with a rectangular cross section in the circumferential direction. In the case of a switch which is intended for typical rated voltages of 200 to 300 kV and typical rated short-circuit disconnection currents of 50 to 70 kA, the heating volume 7 may in general hold about 1 to 2 liters of pressurized quenching gas.

When the chamber is in the connected position, which is not illustrated, the left-hand end of the arcing contact 4 is pushed into the right-hand end of the tubular arcing contact 3, such that it carries current. During disconnection, the two arcing contacts 3, 4 are disconnected from one another and in the process form an arc 8 based on the two ends of the arcing contacts, and this arc burns in an arcing zone 9, as can be seen from FIG. 1. The arcing zone 9 is axially bounded by the two arcing contacts 3, 4 and is radially bounded by the insulating nozzle 6 and an insulating auxiliary nozzle 11. The arcing zone 9 communicates with a heating channel 10. The heating channel 10 is routed partially axially between the insulating nozzle 6 and the insulating auxiliary nozzle 11 and opens with a section 12, which is inclined inward with respect to the axis 5, into the heating volume 7. The inclination angle is a. The insulating auxiliary nozzle 11 comprises the free end, formed by contact fingers of the arcing contact 3 in the circumferential direction.

During one half-cycle of the current to be disconnected, the pressure in the arcing zone 9 is in general higher than in the heating volume 7. The heating channel 10 then carries hot gas, formed by the arc 8, into the heating volume 7. If the heating effect of the arc 8 decreases on approaching the zero crossing of the current, then this is followed by a current reversal. Gas stored in the heating volume 7 flows as quenching gas via the heating channel 10 into the arcing zone 9, where it blows the arc 8 at least until it is quenched at the current zero crossing.

The quality of the quenching gas stored in the heating volume 7 for arc blowing, and therefore also the disconnection rating of the switching chamber, depend on the gas density, which is governed by the pressure and temperature of the quenching gas. The pressure and temperature are governed primarily by the current level and the duration of the switching arc, although they are also governed, inter alia, by the shape and space content of the heating volume 7. While the size of the heating volume 7 influences only the pressure build-up, the shape of the heating volume influences the thorough mixing of the gas and thus the quenching gas temperature. However, the quality of the quenching gas also depends significantly on the flow behavior of the hot gas on its way from the arcing zone 9 into the heating volume 7. Since the mouth section 12 runs into the heating chamber 7 inclined inward, the hot gas, which is identified by a double-headed arrow 13, is provided with a velocity component directed inward, and it is passed along a tubular contact mount 14 of the arcing contact 3 to a rear wall 15 which axially bounds the heating volume in the flow direction The velocity component which is directed inward prevents separation of the hot-gas flow 13 from the contact mount 14, which forms the axially aligned inner wall of the heating volume 7, and therefore allows the hot-gas flow 13 to penetrate deeply into the heating volume in areas close to the axis. A vortex formation process, which promotes the mixing of the hot gas 13 with the cold gas 16, therefore takes place only well away from the opening of the heating channel 10 into the heating volume 7. A hot-gas vortex 17 which is formed during the vortex formation process remains largely stable over a comparatively long time period of several milliseconds because of the low viscosity of the hot gas, so that cold gas 18 remains during this time period at the mouth of the heating channel into the heating volume.

When the current to be disconnected approaches a zero crossing and quenching gas starts to flow out of the heating volume 7 into the arcing zone 9, then cold gas 18 is available as a particularly high-quality quenching gas for blowing the switching arc even at the start of an arc quenching process. A component of the quenching gas which acts later and has been formed by intensive mixing of the hot-gas vortex 17 in the rear part of the heating volume 7 with the cold gas 16 is also of high quality and therefore ensures that short-circuit currents of different magnitude and duration can be successfully interrupted.

As can be seen from FIG. 1, the profile of the mouth section 12, which is inclined inward, reduces the dimensions of the heating volume 7 in the radial direction. As can be seen, the insulating auxiliary nozzle 11 is inclined in the mouth section 12. The inner wall of the heating volume 7 is therefore formed by the contact mount 14, which has a smaller diameter than the insulating auxiliary nozzle 11, of the arcing contact 3, so that the external diameter, which governs the space content of the heating volume 7, of this volume can be reduced.

The inclination angle α may be up to 45°. At larger angles, there is a tendency for the hot-gas flow to separate from the contact mount 14 prematurely. Well configured axial routing of the hot gas 13 into the interior of the heating volume 7, with the heating volume having an external diameter which is kept small at the same time, is achieved with inclination angles α which are between 100 and 30°.

In the exemplary embodiment of the switching chamber according to the disclosure as illustrated in FIGS. 1 and 2, the mouth section 12 is in the form of a hollow truncated cone which tapers in the inclination direction. The hollow truncated cone can be achieved by conical inclination of the insulating auxiliary nozzle 11, forming a conical surface which acts as an inner surface 19 of the hollow truncated cone, forming of a conical surface, which acts as a casing surface 20 of the truncated cone, into the insulating nozzle 6 followed by fixing of the insulating auxiliary nozzle 11 to the contact mount 14 and fixing of the insulating nozzle 6 to the outer wall of the heating volume 7, which is annotated with the reference symbol 21.

The heating channel 10 has a largely constant cross section over its entire length. The flow rate of the hot gas is therefore largely constant throughout the entire heating channel, e.g., even in the mouth section 12. The probability of undesirable premature vortex formation in the heating channel 10 because of flow inhomogeneities is therefore kept low. The constant cross section in the mouth section 12 is achieved by the surface 19 being more sharply inclined than the surface 20.

As can be seen from FIG. 1, the casing surface 20 is bounded at the junction from the mouth section 12 to the heating volume 7 by a sharp edge 22 in the form of a ring. This edge makes it easier for the hot-gas flow 13 to separate from the casing surface 20 therefore assisting the formation of the vortex 17 only on the rear wall 15 of the heating volume. The radius of the edge 22 is typically 0.1 to 1 mm.

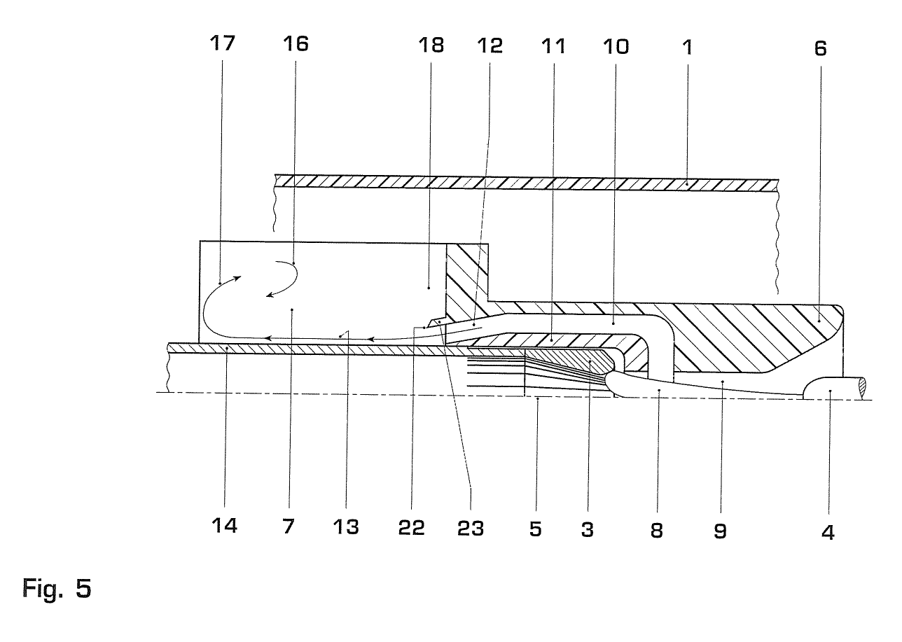

In the exemplary embodiment of the switching chamber shown in FIG. 5, the edge 22 is arranged on a ring 23 which projects into the heating volume in the form of a tab. The ring 23 ensures that the hot-gas flow 13 is guided better in the mouth area.

Instead of a hollow truncated cone, the mouth section 12 may also be shaped differently. As can be seen from FIGS. 3 and 4, the mouth section may have channel elements 12′ (FIG. 3) and 12″ (FIG. 4) arranged offset with respect to one another in the circumferential direction, which may have an approximately circular cross section as illustrated in FIG. 3, or a cross-sectional profile in the form of a banana, as shown in FIG. 4.

It is advantageous for the quality of the quenching gas achieved by mixing of hot gas and cold gas for the ratio of the length of the torus in the axial direction in the heating volume 7 to the height of the torus in the radial direction to be between 1 and 3.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Housing
2 Contact arrangement
3, 4 Contact pieces
Axis
6 Insulating nozzle
7 Heating volume
8 Arc
9 Arcing zone
Heating channel
11 Insulating auxiliary nozzle
12 Mouth section
12′, 12″ Channel elements
13 Hot gas (flow)
14 Contact mount
15 Rear wall
16, 18 Cold gas
17 (Hot gas) vortex
19 Inner surface
20 Casing surface
21 Outer wall
22 Edge
23 Ring

What is claimed is:

1. A switching chamber for a gas-insulated high-voltage switch having a contact arrangement, containing two arcing contacts which move relative to one another along an axis, an insulating nozzle, an insulating auxiliary nozzle, a heating volume and a heating channel which is routed partially axially between the insulating nozzle and the insulating auxiliary nozzle and connects an arcing zone to the heating volume, which heating channel has a section which is inclined inward with respect to the axis and opens into the heating volume, wherein the heating channel has a largely constant cross section over its entire length.

2. The switching chamber as claimed in claim 1, wherein the inclination angle (α) is at most 45°.

3. The switching chamber as claimed in claim 2, wherein the inclination angle (α) is between 0° and 30°.

4. The switching chamber as claimed in claim 1, wherein the mouth section is in the form of a hollow truncated cone which tapers in the inclination direction.

5. The switching chamber as claimed in claim 4, wherein a conical surface of the insulating auxiliary nozzle which acts as the inner surface of the truncated cone is more sharply inclined than a conical surface of the insulating nozzle which acts as the casing surface of the truncated cone.

6. The switching chamber as claimed in claim 5, wherein the casing surface is bounded by a sharp edge, in the form of a ring, at the junction from the mouth section into the heating volume.

7. The switching chamber as claimed in claim 6, wherein the sharp edge is arranged on a ring which projects into the heating volume in the form of a tab.

8. The switching chamber as claimed in claim 1, wherein the mouth section has at least two channel elements which extend in the inclination direction and are arranged offset with respect to one another in the circumferential direction.

9. The switching chamber as claimed in claim 8, wherein the channel elements each have a cross-sectional profile in the form of a banana.

10. The switching chamber as claimed in claim 1, wherein the heating volume is in the form of a torus and has a predominantly rectangular cross section in the circumferential direction, with the ratio of the length of the torus in the axial direction to the height of the torus in the radial direction being between 1 and 3.

11. The high-voltage switch having a switching chamber as claimed in claim 1.

12. The switching chamber as claimed in claim 3, wherein the mouth section is in the form of a hollow truncated cone which tapers in the inclination direction.

13. The switching chamber as claimed in claim 3, wherein the mouth section has at least two channel elements which extend in the inclination direction and are arranged offset with respect to one another in the circumferential direction.

14. The switching chamber as claimed in claim 9, wherein the heating volume is in the form of a torus and has a predominantly rectangular cross section in the circumferential direction, with the ratio of the length of the torus in the axial direction to the height of the torus in the radial direction being between 1 and 3.

15. The high-voltage switch having a switching chamber as claimed in claim 10.

16. A switching chamber arrangement for a gas-insulated high-voltage switch, the arrangement comprising:
a contact arrangement based on two arcing contacts which move relative to one another along an axis;
an insulating nozzle;
an insulating auxiliary nozzle;
a heating volume; and
a heating channel formed partially axial between the insulating nozzle and the insulating auxiliary nozzle, and connecting an arcing zone to the heating volume, which heating channel becomes inclined inward with respect to the axis and opens into the heating volume, wherein the heating channel has a defined cross section of a given length.
